(19) United States
(12) Patent Application Publication
(10) Pub. No.: US 2025/0279716 A1
(43) Pub. Date: Sep. 4, 2025

(54) METHOD FOR CONTROLLING POWER CONVERTER AND POWER CONVERTER

(71) Applicant: Delta Electronics (Shanghai) CO., LTD., Shanghai (CN)

(72) Inventors: Min XU, Shanghai (CN); Kunpeng WANG, Shanghai (CN); Kai DONG, Shanghai (CN); Hui HUANG, Shanghai (CN)

(73) Assignee: Delta Electronics (Shanghai) CO., LTD., Shanghai (CN)

(21) Appl. No.: 19/060,468

(22) Filed: Feb. 21, 2025

(30) Foreign Application Priority Data
Mar. 1, 2024 (CN) 202410238672X

(51) Int. Cl. H02M 1/32; H02M 1/08; H02M 3/07; H02M 3/158; H02M 7/217

(52) U.S. Cl. CPC H02M 1/32; H02M 1/08; H02M 3/07; H02M 3/158; H02M 7/217

(57) ABSTRACT

The present disclosure provides a method for controlling a power converter and a power converter. The power converter includes a first switch, a second switch, a first driving unit corresponding to the first switch and a second driving unit corresponding to the second switch, and a bootstrap capacitor configured to supply power to the second driving unit. When the first switch is turned on, the bootstrap capacitor is charged via the first switch. The method includes: when a duty cycle of the first switch is decreased to a first threshold, controlling the duty cycle of the first switch to be a preset duty cycle every time at least one switching cycle elapses, and the preset duty cycle is not less than the first threshold.

### CROSS REFERENCE

The present application is based on and claims priority to Chinese Patent Application No. 202410238672X, filed on Mar. 1, 2024, the entire contents of which are incorporated herein by reference.

### TECHNICAL FIELD

The present disclosure relates to the field of power supply technologies, and in particular to a method for controlling a power converter and a power converter.

### BACKGROUND

For a power converter whose switching tube is driven by bootstrap driving, for example, as shown in FIGS. 1 and 2, a bootstrap capacitor 205 of an upper switching tube (a second switch 202) needs to be charged by turning on a lower switching tube (a first switch 201) during normal operation. When some special operating conditions, such as no-load, occur, the lower switching tube of the power converter will enter a drive-off state. In this case, the lower switching tube is turned off, a voltage of the bootstrap capacitor 205 of the upper switching tube cannot be effectively supplemented, and a voltage across the bootstrap capacitor will continue to drop. As a result, when the driving of the lower switching tube is restored and the lower switching tube is turned on, the upper switching tube will generate a voltage jump and this voltage jump cannot be absorbed, thereby causing the upper switching tube and the lower switching tube to be turned on simultaneously, so that the circuit is at risk of damage.

It should be noted that the information disclosed in the Background section above is only for enhancing the understanding of the background of the present disclosure, and thus may include information that does not constitute prior art known to those of ordinary skill in the art.

### SUMMARY

The present disclosure provides a method for controlling a power converter and a power converter.

According to a first aspect of the present disclosure, there is provided a method for controlling a power converter,

the power converter includes a first switch, a second switch, a first driving unit corresponding to the first switch and a second driving unit corresponding to the second switch, and a bootstrap capacitor configured to supply power to the second driving unit, when the first switch is turned on, the bootstrap capacitor is charged via the first switch, wherein the method includes:

when a duty cycle of the first switch is decreased to a first threshold, controlling the duty cycle of the first switch to be a preset duty cycle every time at least one switching cycle elapses, wherein the preset duty cycle is not less than the first threshold.

According to a second aspect of the present disclosure, there is further provided a power converter, including:

a first switch and a second switch, electrically connected to form a common node;

a first driving unit, powered by a driving power supply and configured to drive the first switch;

a second driving unit, powered by a bootstrap capacitor and configured to drive the second switch; and

a control unit, electrically connected to the first driving unit and the second driving unit, and configured to:

when a duty cycle of the first switch is decreased to a first threshold, control the duty cycle of the first switch to be a preset duty cycle every time at least one switching cycle elapses, wherein the preset duty cycle is not less than the first threshold.

It should be noted that the above general description and the following detailed description are merely exemplary and explanatory and should not be construed as limiting of the disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure. Apparently, the drawings in the following description are only some embodiments of the present disclosure. For those of ordinary skill in the art, other drawings may be obtained based on these drawings without paying any creative effort.

FIG. 1 shows a schematic structural diagram of a Boost circuit in the prior art;

FIG. 2 shows a schematic structural diagram of a driving circuit of the Boost circuit shown in FIG. 1;

FIG. 3 shows a schematic structural diagram of a totem pole PFC circuit in the prior art;

FIG. 4 shows a schematic diagram of a method for controlling a power converter according to the present disclosure;

FIG. 5 shows a first simulation waveform diagram of a power converter according to the present disclosure;

FIG. 6 shows a second simulation waveform diagram of a power converter according to the present disclosure;

FIG. 7 shows another schematic structural diagram of a driving circuit of the Boost circuit shown in FIG. 1; and

FIG. 8 shows a schematic diagram of an external connection relationship of a power converter according to the present disclosure.

### DETAILED DESCRIPTION

Example embodiments will now be described more fully with reference to the accompanying drawings. However, the example embodiments can be implemented in a variety of forms and should not be construed as being limited to examples set forth herein; rather, these embodiments are provided so that the present disclosure will be more complete and comprehensive so as to convey the idea of the example embodiments to those skilled in this art. The described features, structures or characteristics may be combined in any suitable manner in one or more embodiments.

In addition, the drawings are merely schematic representations of the present disclosure and are not necessarily drawn to scale. The same reference numerals in the drawings denote the same or similar parts, and the repeated description thereof will be omitted. Some of block diagrams shown in the figures are functional entities and do not necessarily correspond to physically or logically separate entities. These functional entities may be implemented in software, or implemented in one or more hardware modules or integrated circuits, or implemented in different networks and/or processor devices and/or microcontroller devices.

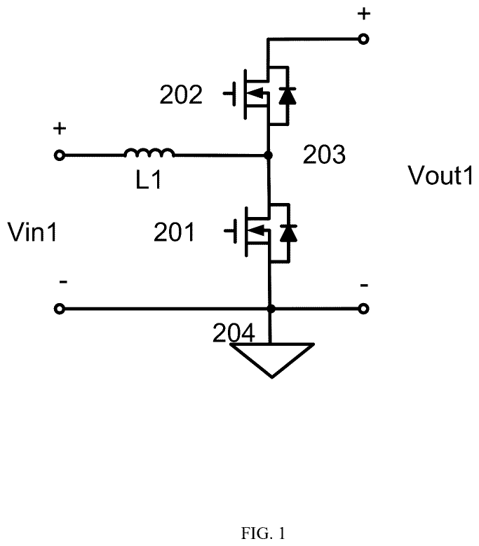

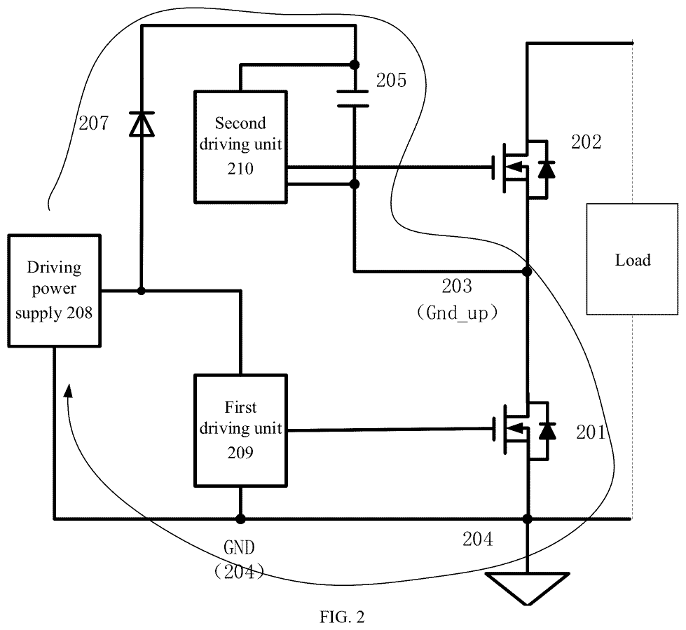

As described above, for a power converter whose switching tube is driven by bootstrap driving, for example, as shown in FIGS. 1 and 2, a bootstrap capacitor 205 of an upper switching tube (a second switch 202) needs to be charged by turning on a lower switching tube (a first switch 201) during normal operation. When some special operating conditions, such as no-load, occur, the lower switching tube of the power converter will enter a drive-off state. In this case, the lower switching tube is turned off, a voltage of the bootstrap capacitor 205 of the upper switching tube cannot be effectively supplemented, and a voltage across the bootstrap capacitor will continue to drop. As a result, when the driving of the lower switching tube is restored and the lower switching tube is turned on, the upper switching tube will generate a voltage jump and this voltage jump cannot be absorbed, thereby causing the upper switching tube and the lower switching tube to be turned on simultaneously, so that the circuit is at risk of damage.

The present disclosure provides a method for controlling a power converter and a power converter, which at least to a certain extent solve a problem in the related arts that the voltage of the bootstrap capacitor of the upper switching tube (the second switch) continues to drop when some special operating conditions (such as no-load) occur. In addition, the present disclosure can also avoid overshoot of an inductor current of the power converter and prevent the output voltage from being too large, thereby protecting the circuit.

In the method for controlling the power converter provided by the present disclosure, the duty cycle of the first switch and the second switch is adjusted to maintain the stability of the voltage of the bootstrap capacitor of the second switch (the upper switching tube), thereby avoiding the situation where the second switch has a voltage jump and the voltage jump cannot be absorbed, thereby causing the first switch and the second switch to be turned on simultaneously and damaging the circuit. In addition, the present disclosure can also avoid the overshoot of the inductor current and prevent the output voltage from being too large.

Specific embodiments of the present disclosure are described in detail below in conjunction with the accompanying drawings.

As shown in FIG. 1, when a power converter is a Boost circuit, the power converter includes:

an input terminal Vin1 which includes a first input terminal Vin1+ and a second input terminal Vin1—, and an output terminal Vout1 which includes a first output terminal Vout1+and a second output terminal Vout1−; a first switch 201 and a second switch 202 which are electrically connected between the first output terminal Vout1+ and the second output terminal Vout1−, where an electrical connection point of the first switch 201 and the second switch 202 forms a common node 203, the first switch 201 is electrically connected between the common node 203 and the second output terminal Vout1−, and the second switch 202 is electrically connected between the first output terminal Vout1+ and the common node 203; and an inductor L1, electrically connected between the first input terminal Vin1+ and the common node 203. The second input terminal Vin1− and the second output terminal Vout1− are electrically connected to a ground terminal 204.

As shown in FIG. 2, a driving circuit of the Boost circuit shown in FIG. 1 includes:

a first driving unit 209, a first terminal of which is electrically connected to a control terminal of the first switch 201, a second terminal of which is electrically connected to the ground terminal 204, and controlling the on and off of the first switch 201;

a second driving unit 210, a first terminal of which is electrically connected to a control terminal of the second switch 202, a second terminal of which is electrically connected to the common node 203, and controlling the on and off of the second switch 202;

a bootstrap capacitor 205, a first terminal of which is electrically connected to a third terminal of the second driving unit 210, and a second terminal of which is electrically connected to the common node 203;

a driving power supply 208, a first terminal of which is electrically connected to a third terminal of the first driving unit 209 and an anode of a diode 207, and a second terminal of which is electrically connected to the ground terminal 204, a cathode of the diode 207 is electrically connected to the third terminal of the second driving unit 210.

In this embodiment, the driving power supply 208 is a Direct Current (DC) power supply. The first switch 201 and the second switch 202 may be switching tubes, including but not limited to Metal-Oxide-Semiconductor Field-Effect Transistors (MOSFETs) and Insulated Gate Bipolar Transistors (IGBTs). The first driving unit 209 and the second driving unit 210 include but are not limited to driving chips.

In this embodiment, a driving mode of the power converter is bootstrap driving. Since a reference ground of the first driving unit 209 and a reference ground of the driving power supply 208 are both the ground terminal 204, the driving power supply 208 can directly supply power to the first driving unit 209, and accordingly, a voltage across the first driving unit 209 is stable. As for the second driving unit 210, since its reference ground is the common node 203 (Gnd_up) of the first switch 201 and the second switch 202, which is a voltage jump point, the driving power supply 208 cannot directly supply power to the second driving unit 210. The bootstrap capacitor 205 is required to supply power to the second driving unit 210. However, when the bootstrap capacitor 205 is charged, the first switch 201 needs to be turned on to form a loop for charging the bootstrap capacitor 205. That is, when the first switch 201 is turned on, the bootstrap capacitor 205, the first switch 201, the driving power supply 208 and the diode 207 form a charging loop to charge the bootstrap capacitor 205.

Under normal operating conditions, the first switch 201 can achieve the charge and discharge balance of the bootstrap capacitor 205. But in special cases where the driving of the first switch 201 needs to be turned off, such as no-load, the first switch 201 remains off, so that the charging loop is disconnected, and the voltage of the bootstrap capacitor 205 gradually decreases. As a result, the second driving unit 210 loses power and cannot absorb the current from both terminals (gate-source) of G and S of the second switch 202. When the driving of the first switch 201 is re-enabled and turned on, a voltage jump occurs between the gate and the source of the second switch 202. This voltage jump cannot be absorbed, which may cause the first switch 201 and the second switch 202 to be turned on simultaneously, so that the circuit is at risk of damage.

For the power converter shown in FIG. 1, when the circuit operates in a special condition and a duty cycle of the first switch 201 gradually decreases or even becomes zero, it is necessary to forcibly change the duty cycle of the first switch 201 to a non-zero value. This ensures the charge and discharge balance of the bootstrap capacitor 205 of the second switch 202, allowing the circuit to operate normally. For all power converters, when the special operating condition such as a no-load state occurs or the load is switched and the duty cycle of the first switch is continuously reduced, the duty cycle of the first switch may be extremely small or even zero. In these cases, it is necessary to adopt a control method in the present disclosure to provide sufficient energy for the bootstrap capacitor. For a power converter whose input power supply is an Alternating Current (AC) power supply, such as a totem pole PFC circuit, the special operating conditions also include that when the input power supply of the circuit is powered off and has not yet been restored. Since a polarity of the input power supply after restoration is unknown, it is impossible to determine whether the first switch or the second switch is a main switching tube. Therefore, it is necessary to force the duty cycles of the first switch and the second switch to be reduced to zero. In this case, the control method disclosed herein is also required to provide sufficient energy for the bootstrap capacitor.

It should be noted that the power converter includes two switches, and the second switch (the upper switching tube) needs to be powered by the bootstrap capacitor for driving. The power converter may have a variety of specific forms, which can be set according to actual circuit requirements. For example, the power converter may include a Boost circuit, a totem pole Power Factor Correction (PFC) circuit or a three-phase PFC circuit.

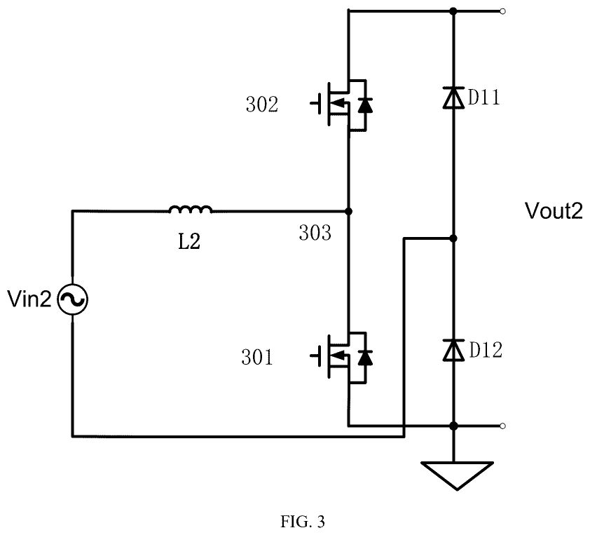

When the power converter is the totem pole PFC circuit, FIG. 3 shows a schematic structural diagram of a totem pole PFC circuit in the prior art, which includes: a first switch 301, a second switch 302, an input power supply Vin2, an inductor L2, a first diode D11, a second diode D12 (either or both of the two diodes may be replaced by a switch), and an output terminal Vout2. A first terminal (a first input terminal) of the input power supply Vin2 is connected to a first terminal of the inductor L2, and a second terminal of the inductor L2 is connected to a common node 303 of the first switch 301 and the second switch 302. A second terminal of the second switch 302 is connected to a cathode of the first diode D11, a first terminal of the first switch 301 is connected to an anode of the second diode D12, and a common node formed by a cathode of the second diode D12 and an anode of the first diode D11 is connected to a second terminal (a second input terminal) of the input power supply Vin2. The cathode of the first diode D11 is electrically connected to a first output terminal Vout2+ of the output terminal Vout2, and the anode of the second diode D12 is electrically connected to a second output terminal Vout2− of the output terminal Vout2.

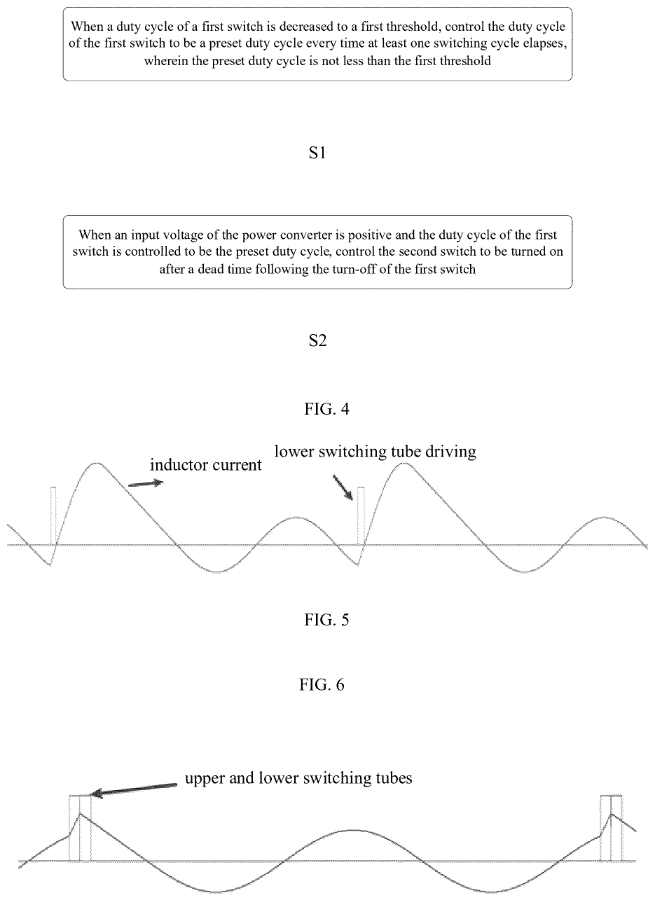

Embodiments of the present disclosure provide a method for controlling a power converter, applicable to a Boost circuit or a PFC circuit in which both switches on one bridge arm are switching tubes. However, when the specific structure of the circuit is different, a turn-on sequence of the first switch and the second switch is different. As shown in FIG. 4, the control method in the present disclosure includes:

In S1, when a duty cycle of the first switch decreases to a first threshold, the duty cycle of the first switch is controlled to be a preset duty cycle every time at least one switching cycle elapses, and the preset duty cycle is not less than the first threshold.

For the step S1, when the power converter is in different states, a change direction (increase/decrease) of the duty cycle of the first switch (the lower switching tube) is different. As mentioned above, the premise of the present disclosure is that the power converter enters a special operating condition, thereby causing the duty cycle of the first switch to gradually decrease or even become zero. In this case, in order to prevent the bootstrap capacitor of the second switch from continuously losing power, the duty cycle of the first switch is forcibly changed to a preset duty cycle when the duty cycle of the first switch is reduced to the first threshold. Accordingly, the first switch does not remain off continuously. Instead, whenever the first switch is turned on, the driving power supply charges the bootstrap capacitor, thereby stabilizing the voltage of the bootstrap capacitor. In addition, if the driving power supply charges the bootstrap capacitor enough each time the first switch is turned on, the first switch may also be turned on once every several switching cycles, which also help stabilize the voltage of the bootstrap capacitor. An interval of the switching cycle can be set according to actual needs.

In some special operating conditions, when the first switch is used as a main switching tube, the duty cycle of the first switch should gradually become zero. However, the control method disclosed herein forces it to become the preset duty cycle. Although the voltage of the bootstrap capacitor of the second switch is stabilized, this also bring another problem, that is, an output voltage continues to increase, which also affects the operating condition of the power converter. As shown in FIG. 5, where the driving waveforms are all driving waveforms of the first switch (the lower switching tube). This is because: the inductor resonates with a parasitic capacitor of the first switch and a parasitic capacitor of the second switch. As a result, an inductor current continues to increase after the first switch is turned off and before a parasitic diode of the second switch is turned on. To solve this problem, it is necessary to turn on the second switch in time after the first switch is turned off and to forcibly adjust a duty cycle of the second switch. In some embodiments, for the convenience of design, the duty cycle of the second switch is also set to the preset duty cycle. This forcibly changes a current commutation path, allowing the inductor current to decrease in time and ending resonance in advance. This ensures that the output voltage does not become too large, thereby effectively protecting the circuit. As shown in FIG. 6, where the driving waveforms are driving waveforms of the first switch (the lower switching tube) and the second switch (the upper switching tube) in sequence. Therefore, the control method further includes:

in S2, when an input voltage of the power converter is positive and the duty cycle of the first switch is controlled to be the preset duty cycle, the second switch is controlled to be turned on after a dead time following the turn-off of the first switch.

In some embodiments, for the step S2, the duty cycle of the second switch is also the preset duty cycle.

In some embodiments, in order to avoid a short circuit caused by turning on two switches at the same time, the second switch may be turned on after a period of time has elapsed since the first switch was turned off. This period of time is called the dead time, and the specific duration of the dead time may be set according to actual needs.

In some embodiments, the polarity of the input voltage may be determined based on a type of the input power supply of the power converter. When the input power supply is a DC power supply, the input voltage is a DC voltage and is always considered positive. When the input power supply is an AC power supply, the input voltage of the power converter is positive during the positive half cycle of the AC power supply.

For the Boost circuit shown in FIG. 1, its input power supply Vin1 is a DC power supply. No matter the inductor L1 is connected to the positive or negative electrode of the input power supply Vin1, the input voltage can be considered to be positive. This is because the first switch 201 functions as the main switching tube, while the second switch 202 always acts as a synchronous rectifier tube. For a conventional Boost circuit using a pulse width modulation, under normal circumstances, the duty cycle of the first switch 201 (the lower switching tube) will gradually decrease to zero when the Boost circuit is in a special operating condition, such as no-load. As mentioned above, if this is not changed, when the duty cycle of the first switch 201 is zero, the charging loop of the bootstrap capacitor 205 of the second switch 202 (the upper switching tube) is disconnected, causing the voltage of the bootstrap capacitor 205 to gradually decrease. In order to stabilize the voltage of the bootstrap capacitor 205 of the second switch 202, the present disclosure forcibly changes the normal change process of the duty cycle of the first switch 201 when the duty cycle of the first switch 201 is reduced to the first threshold. The duty cycle of the first switch 201 is then adjusted to the preset duty cycle, thereby ensuring the charging of the bootstrap capacitor 205 of the second switch 202. The preset duty cycle is a non-zero value, selected within a specific range. The maximum value and minimum value of the specific range will be described in detail below. In addition, since the first switch 201 is always the main switching tube, controlling the duty cycle of the first switch 201 to the preset duty cycle will cause the output voltage to increase continuously (as described above). Therefore, after the first switch 201 is turned on with the preset duty cycle, the second switch 202 needs to be turned on immediately after the dead time.

For the totem pole PFC circuit shown in FIG. 3, since the input power supply Vin2 is an AC power supply, there are two directions of the input voltage, and an input voltage in the positive half cycle of the AC power supply is defined as positive. In this case, the first switch 301 is used as the main switching tube, and the second switch 302 is used as the synchronous rectifier tube. When the first switch 301 is turned on, the current path is: the input power supply Vin2→the inductor L2→the first switch 301→the second diode D12→the input power supply Vin2. It should be understood that in the negative half cycle of the AC power supply, the second switch 302 is used as the main switching tube, and the first switch 301 is used as the synchronous rectifier tube. When the second switch 302 is turned on, the current path is: the input power supply Vin2→the first diode D11→the second switch 302→the inductor L2→the input power supply Vin2. Therefore, when the input voltage is positive, that is, during the positive half cycle of the AC power supply, the problem of the output voltage continuously increasing due to the duty cycle of the first switch 301 being set to the preset duty cycle will occur. Therefore, it is necessary to turn on the second switch 302 immediately after the first switch 301 is turned on with the preset duty cycle. To address this, the second switch 302 is turned on after the dead time. In the negative half cycle of the AC power supply, the second switch 302 is the main switching tube, and the duty cycle of the first switch 301 is set to the preset duty cycle, which does not cause the output voltage to increase. Therefore, it is not necessary to turn on the second switch 302 immediately after the first switch 301 is turned on with the preset duty cycle.

In some embodiments, when the power converter is the Boost circuit, the totem pole PFC circuit or the three-phase PFC circuit, the duty cycle of the first switch gradually decreases to zero in a no-load state according to a conventional control strategy. In this case, when the duty cycle of the first switch is reduced to the first threshold, the change process of the duty cycle of the first switch is forcibly changed to make the duty cycle of the first switch become the preset duty cycle, thereby ensuring the charging of the bootstrap capacitor and stabilizing the voltage of the bootstrap capacitor. If the power converter is in a load switching state, for a case where the duty cycle of the first switch gradually decreases, there is a state in which the duty cycle of the first switch is reduced to the first threshold. In this case, if the change process of the duty cycle of the first switch is not forcibly changed, the duty cycle of the first switch may be reduced to below the first threshold (which is not necessarily zero). In this case, the charging of the bootstrap capacitor is not sufficient to drive the normal operation of the second switch, affecting the normal operation of the circuit. For this, it is also necessary to adopt the control method in the present disclosure. When the duty cycle of the first switch is reduced to the first threshold, the duty cycle of the first switch is forcibly changed to become the preset duty cycle, thereby stabilizing the voltage of the bootstrap capacitor and maintaining the normal operation of the circuit.

In some embodiments, when the power converter is the totem pole PFC circuit, if the input power of the circuit is powered off and has not yet been restored, the conventional control strategy requires reducing the duty cycle of the first switch and the second switch to be reduced to zero. Therefore, when the duty cycle of the first switch is reduced to the first threshold, in order to stabilize the voltage of the bootstrap capacitor, the duty cycle of the first switch is forcibly changed to the preset duty cycle.

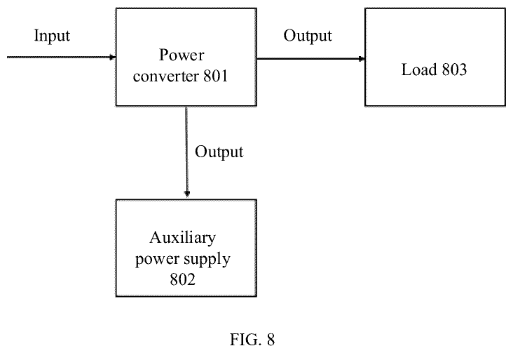

In some embodiments, a selection range of the preset duty cycle has the minimum value and the maximum value. The minimum value of the preset duty cycle is defined as the first threshold. Specifically, the minimum value (the first threshold) of the preset duty cycle may be determined based on the sum of the energy required to drive the second driving unit and the energy required to turn on the second switch. That is to say, when the first switch is turned on according to the minimum value of the preset duty cycle, the energy provided by the driving power supply is greater than the sum of the energy required to drive the second driving unit and the energy required to turn on the second switch. In addition, as shown in FIG. 8, the maximum value of the preset duty cycle may be determined based on an input power when the input voltage of the power converter 801 is maximum and the power consumed by an auxiliary power supply 802 electrically connected to the output terminal of the power converter 801. When the first switch is turned on with the maximum value of the preset duty cycle, and the input voltage of the power converter 801 is at its maximum, the input power of the power converter 801 is less than the power consumed by the auxiliary power supply 802. This is because: in order to maintain the voltage stability of the bootstrap capacitor, the first switch needs to be turned on according to the preset duty cycle, but it also brings a new problem: when the input voltage of the power converter is relatively high, the output voltage will continue to increase if the first switch is turned on according to a larger preset duty cycle, thereby causing damage to the circuit. This is because the premise the present disclosure is that the power converter enters a special operating condition where the power consumed by the load of the power converter is small or close to zero. Since the auxiliary power supply is electrically connected to the output terminal of the power converter, the power output by the power converter is mainly used to supply energy to the auxiliary power supply. The energy consumed by the auxiliary power supply is used to maintain the normal operation of the circuit. Only when the input power is less than the power consumed by the auxiliary power supply, the output voltage will not continue to increase, thereby effectively protecting the circuit.

By determining the minimum and maximum values of the preset duty cycle, a value range of the preset duty cycle can be determined, and the value of the preset duty cycle can be selected within this value range. The selection of the specific value of the preset duty cycle can be determined according to actual needs.

It can be seen that in the method for controlling the power converter provided by the present disclosure, it is only necessary to change the duty cycle of the first switch when the power converter enters the special operating condition, and turn on the second switch in time when the input voltage is positive, so as to maintain the stability of the voltage of the bootstrap capacitor that provides the driving to the second switch, avoiding the circuit damage caused by the direct conduction of the first switch and the second switch. In addition, the present disclosure can also avoid the overshoot of the inductor current and prevent the output voltage from being too large, thereby protecting the circuit. Compared with the structure in the prior art, there is no additional hardware structure, and the safety of the circuit can be greatly improved in a low-cost manner.

Based on the same inventive concept, the present disclosure further provides a power converter, as described in the following embodiments. Since the principle of solving the problem in the power converter embodiment is similar to that in the above method embodiment, the implementation of the power converter embodiment can refer to the implementation of the above method embodiment, and the repeated parts will not be repeated.

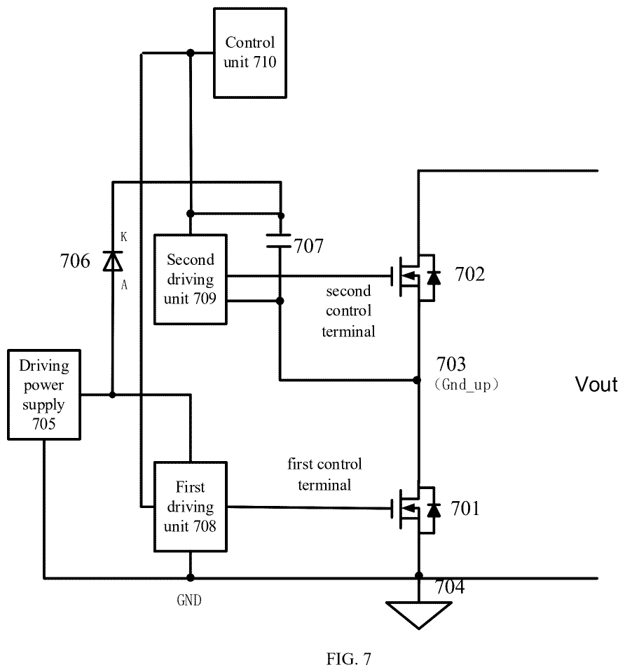

FIG. 7 shows another schematic structural diagram of a driving circuit of the Boost circuit shown in FIG. 1. The driving circuit includes:

a first switch 701, electrically connected to a ground terminal 704 and including a first control terminal;

a second switch 702, electrically connected to the first switch 701 to form a common node 703 (Gnd_up), and including a second control terminal;

a driving power supply 705, electrically connected to the first switch 701 and the ground terminal 704;

a diode 706, where an anode of the diode 706 is electrically connected to the driving power supply 705;

a bootstrap capacitor 707, electrically connected between the common node 703 and a cathode of the diode 706;

a first driving unit 708, electrically connected to the driving power supply 705, the first control terminal of the first switch 701 and the ground terminal 704, and controlling the on and off of the first switch 701;

a second driving unit 709, electrically connected to the bootstrap capacitor 707, the second control terminal of the second switch 702 and the common node 703, and controlling the on and off of the second switch 702; and

a control unit 710, electrically connected to the first driving unit 708 and the second driving unit 709, and configured to:

when a duty cycle of the first switch 701 decreases to a first threshold, control the duty cycle of the first switch 701 to be a preset duty cycle every time at least one switching cycle elapses, and the preset duty cycle is not less than the first threshold.

It should be noted that the driving mode of the power converter is bootstrap driving. When the first switch 701 is turned on, the bootstrap capacitor 707, the first switch 701, the driving power supply 705 and the diode 706 form a charging loop to charge the bootstrap capacitor 707.

The power converter includes the Boost circuit, the totem pole PFC circuit or the three-phase PFC circuit.

In some embodiments of the present disclosure, the control unit 710 is further configured to:

when an input voltage of the power converter is positive and the duty cycle of the first switch 701 is controlled to be the preset duty cycle, control the second switch 702 to be turned on after a dead time following the turn-off of the first switch 701, and the duty cycle of the second switch 702 is the preset duty cycle.

In some embodiments, the power converter further includes an input power supply, and the polarity of the input voltage may be determined based on the type of the input power supply. Specifically, when the input power supply is a DC power supply, the input voltage is a DC voltage, and the input voltage of the power converter is always considered positive. When the input power supply is an AC power supply, the input voltage of the power converter is positive during the positive half cycle of the AC power supply.

In some embodiments, when the power converter is the Boost circuit, the totem pole PFC circuit or the three-phase PFC circuit, the duty cycle of the first switch gradually decreases to zero in a no-load state according to a conventional control strategy. In this case, when the duty cycle of the first switch is reduced to the first threshold, the change process of the duty cycle of the first switch is forcibly changed to make the duty cycle of the first switch become the preset duty cycle, thereby ensuring the charging of the bootstrap capacitor and stabilizing the voltage of the bootstrap capacitor. If the power converter is in a load switching state, for a case where the duty cycle of the first switch gradually decreases, there is a state in which the duty cycle of the first switch is reduced to the first threshold. In this case, if the change process of the duty cycle of the first switch is not forcibly changed, the duty cycle of the first switch may be reduced to below the first threshold (which is not necessarily zero). In this case, the charging of the bootstrap capacitor is not sufficient to drive the normal operation of the second switch, affecting the normal operation of the circuit. For this, it is also necessary to adopt the control method in the present disclosure. When the duty cycle of the first switch is reduced to the first threshold, the duty cycle of the first switch is forcibly changed to become the preset duty cycle, thereby stabilizing the voltage of the bootstrap capacitor and maintaining the normal operation of the circuit.

In some embodiments, when the power converter is the totem pole PFC circuit, if the input power of the circuit is powered off and has not yet been restored, the conventional control strategy requires reducing the duty cycle of the first switch and the second switch to be reduced to zero. Therefore, when the duty cycle of the first switch is reduced to the first threshold, in order to stabilize the voltage of the bootstrap capacitor, the duty cycle of the first switch is forcibly changed to the preset duty cycle.

In some embodiments, the control unit 710 is further configured to determine a range of the preset duty cycle, and the minimum value (i.e., the first threshold) of the preset duty cycle is determined by the sum of the energy required to drive the second driving unit 709 and the energy required to turn on the second switch 702. As shown in FIG. 8, the maximum value of the preset duty cycle is determined by the input power when the input voltage of the power converter 801 is maximum and the power consumed by the auxiliary power supply 802 electrically connected to the output terminal of the power converter. When the first switch 701 is turned on with the maximum value of the preset duty cycle, where the input voltage of the power converter 801 is at its maximum, the input power of the power converter 801 is less than the power consumed by the auxiliary power supply 802.

How the control unit adjusts the duty cycle of the first switch 701 and the second switch 702 and determines the conduction timing of the first switch 701 and the second switch 702 according to the state of the power converter and the direction of the input voltage has been described above, which will not be repeated here.

Those skilled in the art can understand that various aspects of the present disclosure may be implemented as a system, a method, or a program product. Therefore, various aspects of the present disclosure can be embodied in the following forms: a complete hardware implementation, a complete software implementation (including firmware, microcode, etc.), or a combination of hardware and software implementations, which can be collectively referred to as “circuit”, “module’, or “system”. It should be noted that although several modules or units of devices for executing actions in the above detailed description are mentioned, such division of modules or units is not mandatory. In fact, features and functions of two or more of the modules or units described above may be embodied in one module or unit in accordance with embodiments of the present disclosure. Alternatively, the features and functions of one module or unit described above may be further divided into multiple modules or units.

In addition, although various steps of the method of the present disclosure are described in a particular order in the figures, this is not required or implied that the steps must be performed in the specific order, or all the steps shown must be performed to achieve the desired result. Additionally or alternatively, certain steps may be omitted, multiple steps may be combined into one step, and/or one step may be decomposed into multiple steps and so on.

Through the description of the above embodiments, those skilled in the art will readily understand that the example embodiments described herein may be implemented by software or by a combination of software with necessary hardware. Therefore, the technical solutions according to embodiments of the present disclosure may be embodied in the form of a software product, which may be stored in a non-volatile storage medium (which may be a CD-ROM, a USB flash drive, a mobile hard disk, etc.) or on a network. A number of instructions are included to cause a computing device (which may be a personal computer, server, mobile terminal, or network device, etc.) to perform the methods in accordance with embodiments of the present disclosure.

Other embodiments of the present disclosure will be apparent to those skilled in the art after those skilled in the art consider the specification and practice the technical solutions disclosed herein. The present application is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

What is claimed is:

1. A method for controlling a power converter, wherein the power converter comprises a first switch, a second switch, a first driving unit corresponding to the first switch and a second driving unit corresponding to the second switch, and a bootstrap capacitor configured to supply power to the second driving unit, when the first switch is turned on, the bootstrap capacitor is charged via the first switch, and wherein the method comprises:
when a duty cycle of the first switch is decreased to a first threshold, controlling the duty cycle of the first switch to be a preset duty cycle every time at least one switching cycle elapses, wherein the preset duty cycle is not less than the first threshold.

2. The method according to claim 1, further comprising:
when an input voltage of the power converter is positive and the duty cycle of the first switch is controlled to be the preset duty cycle, controlling the second switch to be turned on after a dead time following the turn-off of the first switch.

3. The method according to claim 2, wherein a duty cycle of the second switch is equal to the preset duty cycle.

4. The method according to claim 2, wherein the input voltage of the power converter being positive comprises the input voltage being a direct current voltage or the input voltage being a positive half cycle of an alternating current power supply.

5. The method according to claim 1, wherein when the power converter is in a no-load state, when a load is switched and the duty cycle of the first switch is gradually decreased, or when an input power supply of the power converter is an alternating current power supply that has been powered off and has not yet been restored, a state in which the duty cycle of the first switch is decreased to the first threshold occurs.

6. The method according to claim 1, wherein the preset duty cycle is provided with a minimum value and a maximum value, and the minimum value of the preset duty cycle is equal to the first threshold.

7. The method according to claim 6, further comprising:
determining the first threshold based on a sum of energy required to drive the second driving unit and energy required to turn on the second switch.

8. The method according to claim 6, further comprising:
determining the maximum value of the preset duty cycle based on an input power when an input voltage of the power converter is maximum and a power consumed by an auxiliary power supply electrically connected to an output terminal of the power converter, wherein the input power is less than the power consumed by the auxiliary power supply.

9. The method according to claim 1, wherein the power converter comprises a Boost circuit, a totem pole Power Factor Correction (PFC) circuit or a three-phase PFC circuit.

10. A power converter, comprising:
a first switch and a second switch, electrically connected with each other to form a common node;
a first driving unit, powered by a driving power supply and configured to drive the first switch;
a second driving unit, powered by a bootstrap capacitor and configured to drive the second switch; and
a control unit, electrically connected to the first driving unit and the second driving unit, and configured to:
when a duty cycle of the first switch is decreased to a first threshold, control the duty cycle of the first switch to be a preset duty cycle every time at least one switching cycle elapses, wherein the preset duty cycle is not less than the first threshold.

11. The power converter according to claim 10, further comprising:
a diode, wherein an anode of the diode is electrically connected to the driving power supply and the first driving unit, and a cathode of the diode is electrically connected to the bootstrap capacitor and the second driving unit, and when the first switch is turned on, the bootstrap capacitor is charged by the driving power supply via the first switch.

12. The power converter according to claim 10, wherein the control unit is further configured to:
when an input voltage of the power converter is positive and the duty cycle of the first switch is controlled to be the preset duty cycle, control the second switch to be turned on after a dead time following the turn-off of the first switch.

13. The power converter according to claim 12, wherein a duty cycle of the second switch is equal to the preset duty cycle.

14. The power converter according to claim 12, wherein the input voltage of the power converter being positive comprises the input voltage being a direct current voltage or the input voltage being a positive half cycle of an alternating current power supply.

15. The power converter according to claim 10, wherein when the power converter is in a no-load state, when a load is switched and the duty cycle of the first switch is gradually decreased, or when an input power supply of the power converter is an alternating current power supply that has been powered off and has not yet been restored, a state in which the duty cycle of the first switch is decreased to the first threshold occurs.

16. The power converter according to claim 10, wherein the preset duty cycle is provided with a minimum value and a maximum value, and the minimum value of the preset duty cycle is equal to the first threshold.

17. The power converter according to claim 10, wherein the control unit is further configured to:
determine the first threshold based on a sum of energy required to drive the second driving unit and energy required to turn on the second switch.

18. The power converter according to claim 10, wherein the control unit is further configured to:
determine the maximum value of the preset duty cycle based on an input power when an input voltage of the power converter is maximum and a power consumed by an auxiliary power supply electrically connected to an output terminal of the power converter, wherein the input power is less than the power consumed by the auxiliary power supply.

19. The power converter according to claim 10, wherein the power converter comprises a Boost circuit, a totem pole Power Factor Correction (PFC) circuit or a three-phase PFC circuit.
